(19) United States
(12) Patent Application Publication
(10) Pub. No.: US 2009/0279283 A1
(43) Pub. Date: Nov. 12, 2009

(54) LOW-PRESSURE GAS DISCHARGE LAMP

(75) Inventors: Wouter Johannes Marcel Schrama, Maarheeze (NL); Albertus Aemilius Seyno Sluijterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,015

(22) PCT Filed: Jun. 21, 2007
(86) PCT No.: PCT/IB07/52406

§ 371 Date: Dec. 16, 2008

(30) Foreign Application Priority Data
Jun. 22, 2006 (EP) 06115874.7
Sep. 20, 2006 (EP) 06120945.8

(51) Int. Cl. G02F 1/13357; H01J 1/62

(52) U.S. Cl. 362/97.2; 313/486; 313/487

(57) ABSTRACT

The invention relates to a low-pressure gas discharge lamp (10) for use in a scanning or blinking backlighting system, the low-pressure gas discharge lamp (10) comprising a luminescent layer (20) comprising a luminescent material selected from a group comprising: (Sr_{1-x-y-z}, Baₓ, Ca_{y}, Eu(II)_{z})2Si0₄ (also known as XSO), (Sr_{1-x-y-z}, Baₓ, Ca_{y}, Eu(II)_{z})Si₂N₂O₂ (also known as XSON), and (Sr_{1-x-y-z}, Baₓ, Ca_{y}, Eu(II)_{z})₂Si₅N₈ (also known as XSN), wherein 0≦x<1, 0≦y<, 0<z≦0.20, and x+y+z≦1. The luminescent materials according to the invention have a relatively short decay time (less than 0.5 milliseconds), resulting in a relatively short afterglow time of the low-pressure gas discharge lamp (10) according to the invention. When using known low-pressure gas discharge lamps, for example, comprising the luminescent materials BAM, LAP and YOX in the scanning or blinking backlighting system, the afterglow time of these luminescent materials creates visible motion artifacts, especially when the scanning or blinking time is increased from 50 Hertz or 60 Hertz to, for example, 90 Hertz or 100 Hertz. Replacing the known luminescent materials LAP and/or YOX with luminescent material according to the invention will result in a reduction of the motion artifacts.

### FIELD OF THE INVENTION

The invention relates to a low-pressure gas discharge lamp for a backlighting system arranged for being operated in a scanning mode of operation or in a blinking mode of operation.

### BACKGROUND OF THE INVENTION

Low-pressure gas discharge lamps generally comprise a discharge vessel having a luminescent layer comprising a luminescent material. The luminescent layer generally is applied to an inner wall of a discharge vessel. The luminescent material converts UV light emitted from the discharge space into light of increased wavelength, typically visible light, which is subsequently emitted by the low-pressure gas discharge lamp. Such discharge lamps are also referred to as fluorescent lamps. Low-pressure gas discharge lamps for general illumination purposes usually comprise a mixture of luminescent materials, where the combination of the luminescent materials determines the color of the light emitted by a fluorescent lamp. Examples of commonly used luminescent materials are, for example, a blue-luminescent europium-activated barium magnesium aluminate, BaMgAl₁₀O₁₇:Eu²⁺ (also referred to as BAM), a green-luminescent cerium-terbium co-activated lanthanum phosphate, LaPO₄:Ce,Tb (also referred to as LAP) and a red-luminescent europium-activated yttrium oxide, Y₂O₃:Eu (also referred to as YOX).

The discharge vessel of the low-pressure gas discharge lamp is usually constituted by a light-transmitting envelope enclosing a discharge space in a gastight manner. The discharge vessel is generally tubular and comprises both elongate and compact embodiments. Normally, the means for generating and maintaining a discharge in the discharge space are electrodes arranged near the discharge space. Alternatively, the low-pressure gas discharge lamp is a so-called electrodeless low-pressure gas discharge lamp, for example, an induction lamp where energy required for generating and/or maintaining the discharge is transferred through the discharge vessel by means of an induced alternating electromagnetic field.

Low-pressure gas discharge lamps are often used in backlighting units. Such backlighting units are used as a light source in, for example, non-emissive display devices, such as liquid crystal display devices, also referred to as LCD panels, which are used in, for example, television receivers and (computer) monitors for projecting images or displaying a television program, a film, a video program or a DVD, or the like. In backlighting units typically three primary colors are emitted, for example, the primary colors Red, Green and Blue. A primary color comprises light of a predefined spectral bandwidth around a specific wavelength. By using Red, Green and Blue, a full color image, including white, can be generated by the display device. Also other combinations of primary colors may be used in the display device, which enable the generation of full color images, for example, Red, Green, Blue, Cyan and Yellow. Thus, the number of primary colors used in backlighting units of display devices may vary.

Often, the backlighting unit comprises a plurality of low-pressure gas discharge lamps arranged adjacent to one another in a plane parallel to the display device. The plurality of low-pressure gas discharge lamps may be operated in a continuous mode of operation, or may be operated in a scanning mode of operation, or may be operated in a blinking mode of operation. During the continuous mode of operation, the plurality of low-pressure gas discharge lamps emits light continuously during the time an image is being displayed on the display device, the so-called frame time. During the scanning mode of operation or the blinking mode of operation, the low-pressure gas discharge lamps are switched on and off sequentially such that each low-pressure gas discharge lamp only emits light during a part of the frame time. When using a scanning mode of operation or a blinking mode of operation in a backlighting unit which illuminates the LCD panel, the image quality of the LCD panel is improved, especially for moving objects in the displayed image.

In the known LCD panels having a backlighting unit comprising low-pressure gas discharge lamps used in a scanning or blinking mode of operation, motion artifacts are still present.

### SUMMARY OF THE INVENTION

It is an object of the invention to provide a low-pressure gas discharge lamp which reduces the motion artifacts in an LCD panel.

According to a first aspect of the invention, the object is achieved with a low-pressure gas discharge lamp comprising: a light-transmitting discharge vessel enclosing, in a gastight manner, a discharge space comprising a gas filling,

the discharge vessel comprising discharge means for maintaining a discharge in the discharge space emitting light substantially comprising ultraviolet light,

a wall of the discharge vessel being provided with a luminescent layer comprising a luminescent material selected from a group comprising:

(Sr_{1-x-y-z}, Baₓ, Ca_{y}, Eu(II)_{z})₂SiO₄,

(Sr_{1-x-y-z}, Baₓ, Ca_{y}, Eu(II)_{z})Si₂N₂O₂, and

(Sr_{1-x-y-z}, Baₓ, Ca_{y}, Eu(II)_{z})₂Si₅N₈,

wherein 0≦x<1, 0≦y<1, 0<z≦0.20, and x+y+z≦1

for converting ultraviolet light into visible light emitted by the low-pressure gas discharge lamp.

The effect of the measures according to the invention is that a low-pressure gas discharge lamp comprising a luminescent material selected from the group comprising (Sr_{1-x-y-z}, Baₓ, Ca_{y}, Eu(II)_{z})₂SiO₄ (further also referred to as XSO), (Sr_{1-x-y-z}, Baₓ, Ca_{y}, Eu(II)_{z})Si₂N₂O₂ (further also referred to as XSON), and (Sr_{1-x-y-z}, Baₓ, Ca_{y}, Eu(II)_{z})₂Si₅N₈ (further also referred to as XSN (where 0≦x<1, 0≦y<1, 0<z≦0.20, and x+y+z≦1) has a decay time of less than 0.5 milliseconds. Due to the relatively short decay time of the luminescent material, the low-pressure gas discharge lamp according to the invention has a relatively short afterglow time. When luminescent material is used in a low-pressure gas discharge lamp, for example, to convert ultraviolet light into visible light, the luminescent material has an afterglow time, which is a period of time during which the luminescent material still emits light while the low-pressure gas discharge lamp is switched off. The intensity of the light emitted during the afterglow time decays over time. Usually the decay is exponential, and the decay time is defined as a period of time needed for the light intensity to decrease from a first light intensity to a second intensity, which is 1/e times lower than the first light intensity. Due to the afterglow time of the luminescent material, the image is visible longer than desired. The time during which the image is still visible is defined as a “hold-time” of the displayed image, which is a period of time during which the remaining light emitted by the low-pressure gas discharge lamp contributes less than 10% to the total luminance of the image. For a luminescent material having a regular exponential decay, the “hold time” is approximately 2.3 times the decay time. As indicated above, during scanning or blinking, a low-pressure gas discharge lamp of the backlighting system is only switched on during part of the frame time, which is the time during which the image is displayed on the display device. When the hold-time is in the order of magnitude of the frame time, motion artifacts become visible. The known low-pressure gas discharge lamps comprise a mix of luminescent materials to produce substantially white light, for example, BAM, LAP and YOX. Especially the luminescent materials LAP and YOX have a relatively long decay time (approximately 4-5 milliseconds for LAP and approximately 1-2 milliseconds for YOX). Using LAP and YOX in a low-pressure gas discharge lamp of a backlighting system which has a scanning or blinking frequency of, for example, 90 Hertz (resulting in a frame time of approximately 11 milliseconds), the hold-time for the primary color Green may become longer than the frame time and the hold-time for the color red is in the order of magnitude of the frame time. This results in green and red motion artifacts. Using the low-pressure gas discharge lamp according to the invention, the decay time of the luminescent material is less than 0.5 milliseconds and thus motion artifacts will be reduced.

The luminescent materials XSO and XSON emit light of a primary color green and may, for example, replace the green-luminescent LAP in the known low-pressure gas discharge lamps to improve the decay time for the primary color green in the known low-pressure gas discharge lamp. The luminescent material XSN emits light of a primary color red and may, for example, replace the red-luminescent YOX in the known low-pressure gas discharge lamps to improve the decay time for the primary color red.

A further benefit of the low-pressure gas discharge lamp according to the invention is that the scanning frequency or the blinking frequency of the low-pressure gas discharge lamp in a backlighting system can be increased. Currently there is a trend to increase the scanning or blinking frequency of the backlighting system from the commonly available 50 or 60 Hertz to 90 Hertz or 100 Hertz. At the common frequency of 50 or 60 Hertz, a viewer may experience a flashing of the image. By increasing the scanning frequency or the blinking frequency, this flashing of the image experienced by the viewer is reduced. However, increasing the scanning frequency or the blinking frequency of a backlighting system comprising the known low-pressure gas discharge lamp will result in motion artifacts due to a decrease of the frame time while the luminescent materials used still have the relatively long decay times. Using the backlighting system comprising the low-pressure gas discharge lamps according to the invention enables an increase of the scanning frequency or the blinking frequency of the backlighting system substantially without introducing motion artifacts.

In an embodiment of the low-pressure gas discharge lamp, the luminescent layer comprises a first luminescent material selected from a group comprising: (Sr_{1-x-y-z}, Baₓ,Ca_{y},Eu(II)_{z})₂SiO₄ and (Sr_{1-x-y-z},Baₓ,Ca_{y},Eu(II)_{z})Si₂N₂O₂, where 0≦x<1, 0≦y<1, 0<z≦0.20, and x+y+z≦1, for emitting a primary color green, and comprises a second luminescent material (Sr_{1-x-y-z},Baₓ,Ca_{y},Eu(II)_{z})₂Si₅N₈, where 0≦x<1, 0≦y<1, 0<z≦0.20, and x+y+z≦1, for emitting a primary color red. A benefit of this embodiment is that the primary colors green and red are both emitted using luminescent materials having a decay time less than 0.5 milliseconds. When the low-pressure gas discharge lamp further comprises a blue-emitting luminance material, for example, BAM (typically having a decay time of approximately 1.5 microseconds), the hold-time for each of the emitted colors is below 0.5 milliseconds, thereby substantially eliminating motion artifacts resulting from afterglow times of the luminescent materials in the backlighting system.

In an embodiment of the low-pressure gas discharge lamp, the gas filling of the discharge space comprises mercury. A benefit of this embodiment is that an emission of ultraviolet light is relatively efficient, which results in a low-pressure gas discharge lamp having a relatively high efficiency.

In a preferred embodiment of the low-pressure gas discharge lamp, the luminescent layer is arranged at an inner wall of the discharge vessel and an inorganic coating is arranged for covering the luminescent material. A benefit of this embodiment is that the luminescent material is shielded from the discharge environment. Exposure to the discharge environment typically results in a gradual degradation of the luminescent material and as such a gradual decrease of the efficiency of the low-pressure gas discharge lamp. The inorganic coating shields the luminescent material from the discharge environment, thus reducing degradation of the luminescent material, and substantially maintaining efficiency. The inorganic coating may be applied as a coating, for example, on top of the luminescent layer, or, alternatively, on individual particles of the luminescent material in the luminescent layer. In an embodiment of the low-pressure gas discharge lamp, the inorganic coating comprises SiO₂, Al₂O₃, or MgO.

In an embodiment of the low-pressure gas discharge lamp, the low-pressure gas discharge lamp is a Hot Cathode Fluorescent Lamp (further also referred to as HCFL). A benefit of this embodiment is that the HCFL can be switched on and off relatively quickly, which makes the HCFL very suitable for use in a scanning or blinking backlighting system.

The invention also relates to a backlighting system comprising the low-pressure gas discharge lamp according to the invention, the backlighting system being arranged for being operated in a scanning mode of operation or in a blinking mode of operation, and the invention relates to a display system comprising the backlighting system. In a preferred embodiment of the backlighting system, the backlighting system is used in a blinking mode of operation or in a scanning mode of operation.

### BRIEF DESCRIPTION OF THE DRAWINGS

These and other aspects of the invention are apparent from and will be elucidated with reference to the embodiments described hereinafter.

In the drawings:

FIGS. 1A and 1B show a cross-sectional view of a low-pressure gas discharge lamp according to the invention,

FIGS. 2A, 2B and 2C show excitation and emission spectra BOSE, which is a specific variant of XSO, SSON which is a specific variant of XSON, and SSN which is a specific variant of XSN, respectively,

FIGS. 3A and 3B show a display system having the backlighting system according to the invention, wherein the backlighting system is arranged for operating in a scanning mode of operation or for operating in a blinking mode of operation, respectively.

The Figures are purely diagrammatic and not drawn to scale. Particularly for clarity, some dimensions are exaggerated strongly. Similar components in the Figures are denoted by the same reference numerals as much as possible.

### DETAILED DESCRIPTION OF EMBODIMENTS

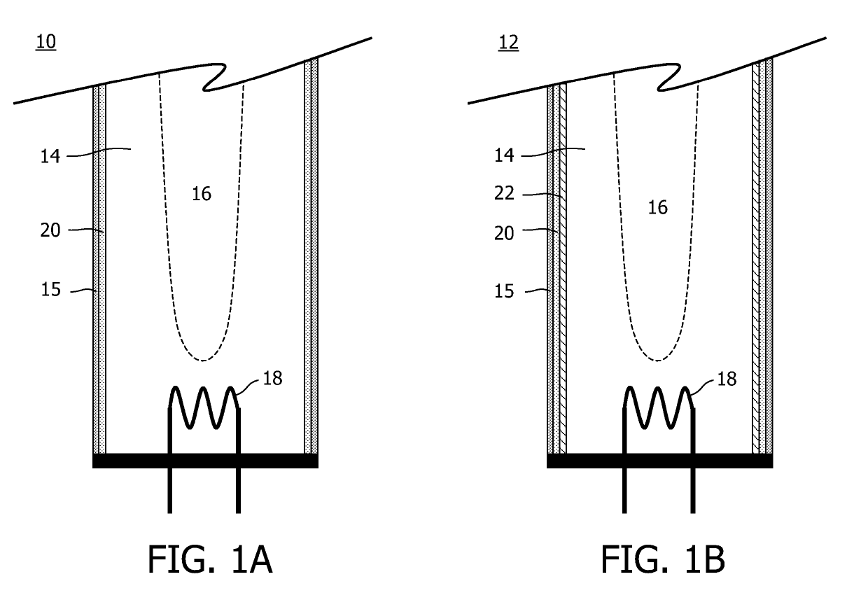

FIGS. 1A and 1B show a cross-sectional view of a low-pressure gas discharge lamp 10, 12 according to the invention. The low-pressure gas discharge lamp 10, 12 according to the invention comprises a light transmitting discharge vessel 14 which encloses a discharge space 16 in a gas-tight manner. The discharge space 16 comprises a gas filling, for example, comprising a metal compound and a buffer gas. The low-pressure gas discharge lamp 10, 12 further comprises coupling elements. The coupling elements couple energy into the discharge space 16, for example, via capacitive coupling, inductive coupling, microwave coupling, or via electrodes 18 to obtain a gas discharge in the discharge space 16. The discharge vessel 14 comprises a wall 15 having a luminescent layer 20 comprising luminescent material. The luminescent material, for example, absorbs ultraviolet light emitted from the discharge and, for example, converts the absorbed ultraviolet light into visible light.

In an embodiment shown in FIGS. 1A and 1B, the discharge vessel 14 comprises a set of electrodes 18. In FIGS. 1A and 1B only one electrode 18 of the set of electrodes 18 is shown. The electrodes 18 are electrical connections through the discharge vessel 14 of the low-pressure gas discharge lamp 10, 12. By applying an electrical potential difference between the two electrodes 18, a discharge is initiated between the two electrodes 18. This discharge is generally located between the two electrodes 18 and is indicated in FIGS. 1A and 1B as the discharge space 16. Alternative coupling elements are capacitive couplers (not shown), inductive couplers (not shown), or microwave couplers (not shown). A benefit when using the alternative coupling elements for generating and/or maintaining the discharge in the low-pressure gas discharge lamp 10, 12 is that the electrodes 18, which generally limit the lifetime of low-pressure gas discharge lamps 10, 12, can be omitted.

In general, light generation in the low-pressure gas discharge lamp 10, 12 is based on the principle that charge carriers, particularly electrons but also ions, are accelerated by an electric field applied between the electrodes 18 of the low-pressure gas discharge lamp 10, 12. Collisions of these accelerated electrons and ions with the gas atoms or molecules in the gas filling of the low-pressure gas discharge lamp 10, 12 cause these gas atoms or molecules to be dissociated, excited or ionized. When the atoms or molecules of the gas filling return to a ground state, a substantial part of the excitation energy is converted to radiation. When the gas filling comprises mercury, the light emitted by the excited mercury atoms is mainly ultraviolet light at a wavelength of approximately 254 nanometer. This ultraviolet light is subsequently absorbed by luminescent material in the luminescent layer 20 which converts the absorbed ultraviolet light, for example, to visible light of a predetermined color. Generally, there is a time delay between the absorption by the luminescent material of an ultraviolet photon (emitted by the mercury atom) and the subsequent emission of, for example, a photon in the visible range by the luminescent material. This time delay is different for different luminescent materials and determines the afterglow time of the luminescent material.

In the low-pressure gas discharge lamps 10, 12, generally the luminescent layer 20 comprises a mixture of luminescent materials which is used to be able to emit substantially white light. In the known low-pressure gas discharge lamps often a mix of the luminescent materials BAM (emitting the primary color blue), LAP (emitting the primary color green) and YOX (emitting the primary color red) is used to obtain substantially white light. These luminescent materials each have a different decay time, as listed in table 1.

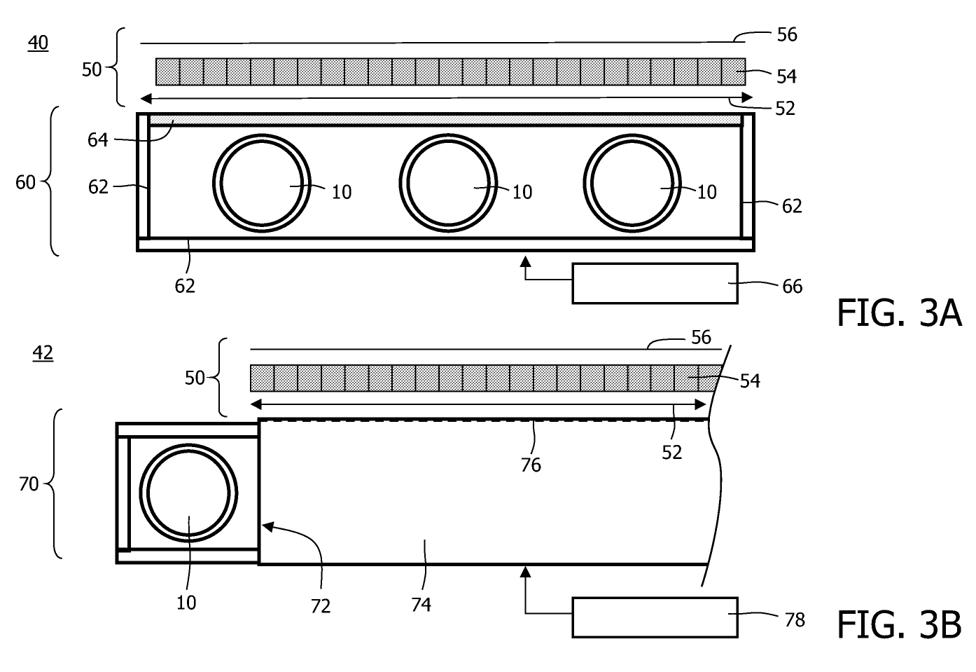

When using the known low-pressure gas discharge lamp in a backlighting system arranged for being operated in a scanning mode of operation (further also referred to as scanning backlighting system 60) or in a blinking mode of operation (further also referred to as blinking backlighting system 70) (see FIG. 3) scanning or blinking at a frequency of 90 Hertz or 100 Hertz, the afterglow of the luminescent materials LAP and YOX is too large. As a result, motion artifacts are visible in display systems which use the known low-pressure gas discharge lamps in the scanning or blinking mode of operation. As indicated before, during scanning or blinking, the low-pressure gas discharge lamp 10, 12 of the backlighting system 60, 70 is only switched on during part of the frame time, which is the time during which the image is displayed on the display device 40. When the hold-time, which is the time during which the image is still visible after the low-pressure gas discharge lamp has been switched off, is in the order of magnitude of the frame time, motion artifacts become visible. In the known low-pressure gas discharge lamp comprising BAM, LAP and YOX, green and red motion artifacts will become visible.

The low-pressure gas discharge lamp 10, 12 according to the invention comprises a luminescent material selected from a group comprising XSO, XSON or XSN. The luminescent materials XSO and XSON emit the primary color green and can, for example, replace the luminescent material LAP in the known mixture of BAM, LAP and YOX. Because the decay times of the luminescent materials XSO and XSON are below 0.5 milliseconds, the motion artifacts are reduced when these luminescent materials are used in the low-pressure gas discharge lamp 10, 12 of a scanning or blinking backlighting system 60, 70 scanning or blinking at a frequency of 90 Hertz or 100 Hertz. The low-pressure gas discharge lamp 10, 12 according to the invention, for example, comprises a mixture of BAM, XSO and YOX or a mixture of BAM, XSON and YOX, which, when applied in a scanning or blinking backlighting system 60, 70, results in a reduction of the motion artifacts, as only red motion artifacts remain visible. The luminescent material XSN emits the primary color red and can, for example, replace the luminescent material YOX in the known mixture of BAM, LAP and YOX. Because the decay times of the luminescent material XSN are below 0.5 milliseconds, the motion artifacts are reduced when this luminescent material is used in the low-pressure gas discharge lamp 10, 12 of a scanning or blinking backlighting system 60, 70 scanning or blinking at a frequency of 90 Hertz or 100 Hertz. The low-pressure gas discharge lamp 10, 12 according to the invention, for example, comprises a mixture of BAM, LAP and XSN, which, when applied in a scanning or blinking backlighting system 60, 70, results in a reduction of the motion artifacts, as only green motion artifacts remain visible.

TABLE 1
decay time of commonly known luminescent materials, wherein
0 ≦ x < 1, 0 ≦ y < 1, 0 < z ≦ 0.20, and x + y + z ≦ 1.

| | Phos- | | |
|---|---|---|---|
| | phor | Chemical formula | Decay time |
| Known | BAM | BaMgAl₁₀O₁₇: Eu²⁺ | ~1.5 microsecond |
| | LAP | LaPO₄: Ce,Tb3⁺ | ~4-5 milliseconds |
| | YOX | Y₂O₃: Eu3⁺ | ~1-2 milliseconds |
| Inven- | XSO | (Sr_{1-x-y-z},Baₓ,Ca_{y},Eu(II)_{z})₂SiO₄ | <0.5 milliseconds |
| tion | XSON | (Sr_{1-x-y-z},Baₓ,Ca_{y},Eu(II)_{z})Si₂N₂O₂ | <0.5 milliseconds |
| | XSN | (Sr_{1-x-y-z},Baₓ,Ca_{y},Eu(II)_{z})₂Si₅N₈ | <0.5 milliseconds |

In a preferred embodiment of the low-pressure gas discharge lamp 10, 12, both luminescent materials LAP and YOX are replaced with the luminescent materials XSO or XSON, and XSN, respectively. This, for example, results in the following mixtures of the luminescent materials: BAM, XSO, XSN, or BAM, XSON, XSN. The use of a low-pressure gas discharge lamp 10, 12 according to the invention comprising one of the listed mixtures of luminescent materials in a scanning or blinking backlighting system 60, 70, results in substantially no motion artifacts at the scanning or blinking frequency of 90 Hertz or 100 Hertz.

In an embodiment of the luminescent material XSO, the labels x, y and z, for example, are chosen to be: x=0.49, y=0 and z=0.02, resulting in (Sr_{0.49}Ba_{0.49}Eu_{0.02})₂SiO₄, further also indicated as BOSE. In an embodiment of the luminescent material XSON, the labels x, y and z, for example, are chosen to be: x=0, y=0, and z=0.02, resulting in (Sr_{0.98}Eu_{0.02})₂Si₂N₂O₂, further indicated as SSON. In an embodiment of the luminescent material XSN, the labels x, y and z, for example, are chosen to be: x=0.98, y=0, and z=0.02, resulting in (Ba_{0.98}Eu_{0.02})₂Si₅N₈, further also indicated as SSN.

In the embodiment of the low-pressure gas discharge lamp 10, 12 shown in FIGS. 1A and 1B, the luminescent layer 20 is applied to the inside of the wall 15 of the discharge vessel 14. Alternatively, the luminescent layer 20 may be applied to the outside (not shown) of the wall 15 of the discharge vessel 14. In the latter embodiment, the discharge vessel 14 must be made of a material which is transparent to ultraviolet light, such as quartz glass.

FIG. 1B shows an embodiment of the low-pressure gas discharge lamp 12 having a luminescent layer 20 which is covered substantially by an inorganic coating 22 which, for example, comprises SiO₂, Al₂O₃, or MgO. This inorganic coating 22 substantially shields the luminescent material from the discharge environment of the discharge space 16, which reduces gradual degradation of the luminescent material in the luminescent layer 20 due to the discharge environment, which degradation causes a decrease in efficiency of the luminescent material. Alternatively, the inorganic coating 22 is applied as a coating to each particle of luminescent material (not shown) rather than covering the luminescent layer 20 as shown in FIG. 1B.

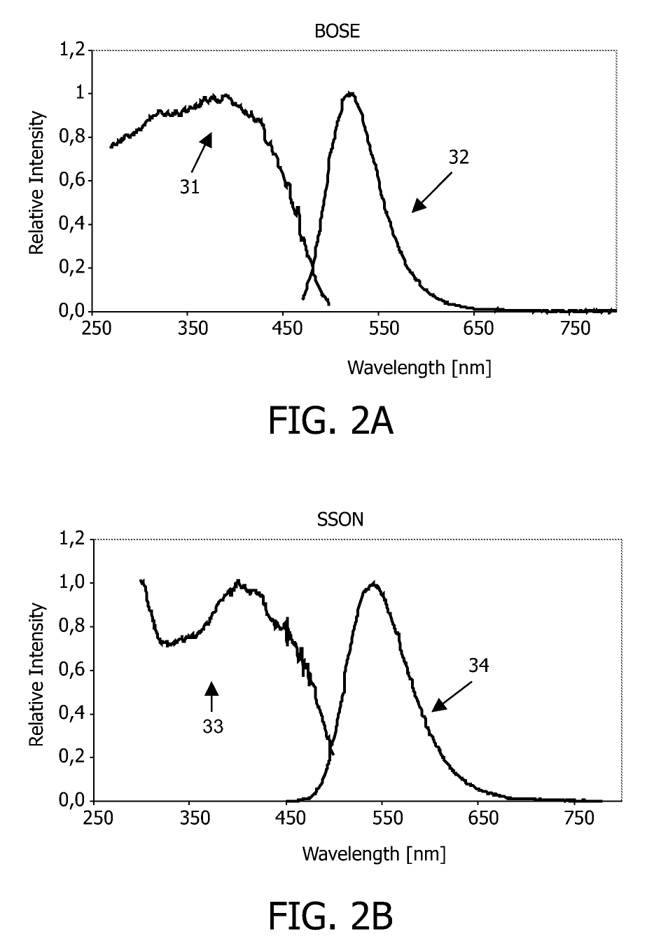

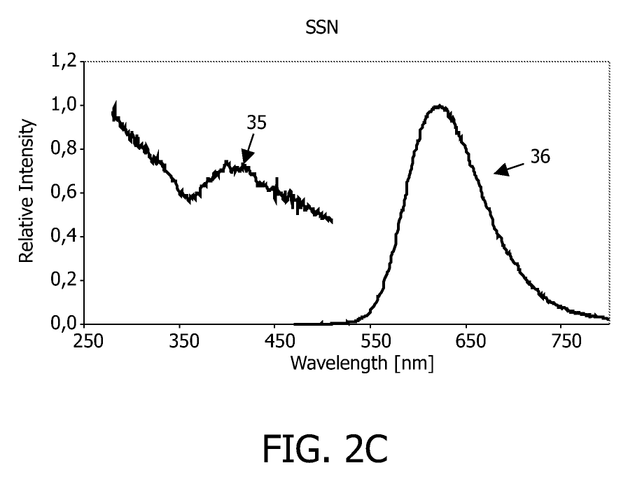

FIG. 2A shows an excitation spectrum 31 and emission spectrum 32 of the low-pressure gas discharge lamp 10, 12 comprising the luminescent material BOSE ((Sr_{0.49}Ba_{0.49}Eu_{0.02})₂SiO₄), as a special variant of XSO, comprising Barium. As can clearly be seen from the excitation spectrum 31 of FIG. 2A, the luminescent material BOSE absorbs ultraviolet light in a UV-A, UV-B and UV-C range where the main emission lines of mercury are located. The emission spectrum 32 of BOSE shows a peak around approximately 520 nanometers, and thus BOSE emits substantially green light (green light is defined between approximately 500 nanometers and 570 nanometers).

FIG. 2B shows an excitation spectrum 33 and emission spectrum 34 of the low-pressure gas discharge lamp 10, 12 comprising the luminescent material SSON ((Sr_{0.98}Eu_{0.02})₂Si₂N₂O₂), as a special variant of XSON, comprising Strontium. The excitation spectrum 33 of FIG. 2B again shows that the luminescent material SSON absorbs ultraviolet light in a UV-A, UV-B and UV-C range where the main emission lines of mercury are located. The emission spectrum 34 of SSON shows a peak around approximately 540 nanometers, and thus also SSON emits substantially green light (green light is defined between approximately 500 nanometers and 570 nanometers).

FIG. 2C shows an excitation spectrum 35 and emission spectrum 36 of the low-pressure gas discharge lamp 10, 12 comprising the luminescent material SSN ((Sr_{0.98}Eu_{0.02})₂Si₅N₈), a special variant of XSN, comprising Strontium. The excitation spectrum 35 of FIG. 2C shows that also the luminescent material SSN absorbs ultraviolet light in a UV-A, UV-B and UV-C range. The emission spectrum 36 of SSN shows a peak around approximately 620 nanometers, and thus SSN emits substantially red light (red light is defined between approximately 610 nanometers and 750 nanometers).

FIG. 3A shows a display system 40 according to the invention having a scanning backlighting system 60 according to the invention. The display system 40 comprises a display device 50, for example a well-known liquid crystal display device. The liquid crystal display device generally contains a polarizer 52, an array of light valves 54 and an analyzer 56. Each light valve 54 typically comprises liquid crystal material which can alter a polarization direction of incident light, for example, by applying an electrical field across the liquid crystal material. The arrangement of polarizer 52, light valve 54 and analyzer 56 is such that when the light valve 54 is switched to, for example, “bright”, the light emitted from the scanning backlighting system 60 will be transmitted. When the light valve 54 is switched to, for example, “dark”, the light emitted from the scanning backlighting system 60 will be blocked. In that way an image can be produced on the display device 50.

The scanning backlighting system 60 as shown in FIG. 3A comprises an array of low-pressure gas discharge lamps 10 which are arranged parallel to each other in a plane substantially parallel to the display device 50. The scanning backlighting system 60 shown in FIG. 3A comprises a plurality of reflective walls 62 reflecting light emitted from the low-pressure gas discharge lamps 10 facing away from the display device 50 back towards the display device 50. The scanning backlighting system 60 further comprises a light exit window 64 facing the display device 50 and emitting the light from the scanning backlighting system 60 towards the display device 50. The scanning backlighting system 60 further comprises a controller 66 for controlling the sequential switching “on” and “off” of the low-pressure gas discharge lamps 10 during the frame time.

FIG. 3B shows a display system 42 according to the invention having a blinking backlighting system 70 according to the invention. The display system 42 comprises a display device 50, which is, for example, identical to the display device 50 shown in FIG. 3A. The blinking backlighting system 70 shown in FIG. 3B comprises a low-pressure gas discharge lamp 10 which emits light via a light entrance window 72 into a light guide 74. The light emitted by the low-pressure gas discharge lamp 10 is distributed in the light guide 74 and emitted towards the display device 50 via a light exit window 76 facing the display device 50. The blinking backlighting system 70 further comprises a controller 78 for controlling the switching “on” and “off” of the low-pressure gas discharge lamp 10 during part of the frame time.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A low-pressure gas discharge lamp (10, 12) for a backlighting system (60, 70) arranged for being operated in a scanning mode of operation or in a blinking mode of operation, the low-pressure gas discharge lamp (10, 12) comprising:
a light-transmitting discharge vessel (14) enclosing, in a gastight manner, a discharge space (16) comprising a gas filling,
the discharge vessel (14) comprising discharge means (18) for maintaining a discharge in the discharge space (16) emitting light substantially comprising ultraviolet light,
a wall (15) of the discharge vessel (14) being provided with a luminescent layer (20) comprising a luminescent material selected from a group comprising:
(Sr1-x-y-z, Bax, Cay, Eu(II)z)2SiO4,
(Sr1-x-y-z, Bax, Cay, Eu(II)z)Si2N2O2, and
(Sr1-x-y-z, Bax, Cay, Eu(II)z)2Si5N8,
wherein 0≦x<1, 0≦y<1, 0<z≦0.20, and x+y+z≦1,
for converting ultraviolet light into visible light emitted by the low-pressure gas discharge lamp (10, 12).

2. Low-pressure gas discharge lamp (10, 12) as claimed in claim 1, wherein the luminescent layer (20) comprises a first luminescent material selected from a group comprising:
(Sr1-x-y-z,Bax,Cay,Eu(II)z)2SiO4, and
(Sr1-x-y-z,Bax,Cay,Eu(II)z)Si2N2O2,
where 0≦x<1, 0≦y<1, 0<z≦0.20, and x+y+z≦1, for emitting a primary color green, and comprises a second luminescent material:
(Sr1-x-y-z,Bax,Cay,Eu(II)z)2Si5N8,
where 0≦x<1, 0≦y<1, 0<z≦0.20, and x+y+z≦1, for emitting a primary color red.

3. Low-pressure gas discharge lamp (10, 12) as claimed in claim 1, wherein the gas filling of the discharge space (16) comprises mercury.

4. Low-pressure gas discharge lamp (10, 12) as claimed in claim 1, the luminescent layer (20) being arranged at an inner wall of the discharge vessel (14), wherein an inorganic coating (22) is arranged for covering the luminescent material.

5. Low-pressure gas discharge lamp (10, 12) as claimed in claim 4, wherein the inorganic coating (22) comprises SiO2, Al2O3, or MgO.

6. Low-pressure gas discharge lamp (10, 12) as claimed claim 1, wherein the low-pressure gas discharge lamp (10, 12) is a Hot Cathode Fluorescent Lamp (10, 12).

7. Backlighting system (60, 70) for illuminating a display device (50), the backlighting system (60, 70) being arranged for being operated in a scanning mode of operation or in a blinking mode of operation, and comprising a low-pressure gas discharge lamp (10, 12) as claimed in claim 1.

8. Backlighting system (60) as claimed in claim 7, the backlighting system (60) comprising a plurality of low-pressure gas discharge lamps (10, 12) arranged parallel to each other in a plane substantially parallel to the display device (50), wherein the plurality of low-pressure gas discharge lamps (10, 12), during operation, are used in a scanning mode of operation.

9. Backlighting system (70) as claimed in claim 7, wherein the low-pressure gas discharge lamp (10, 12), during operation, is used in a blinking mode of operation.

10. Display system (40, 42) comprising a backlighting system (60, 70) as claimed in claim 7.
